(19) United States
(12) Patent Application Publication
(10) Pub. No.: US 2007/0183343 A1
(43) Pub. Date: Aug. 9, 2007

(54) Method and system for facilitating command of a group

(76) Inventors: Liliana Grajales, Bloomingdale, IL (US); Mark A. Krizik, Homer Glen, IL (US); Ion V. Nicolaescu, Carpentersville, IL (US); John B. Preston, Plantation, FL (US); Francesca Schuler, Des Plaines, IL (US); Mansour Toloo, Platine, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/347,408

(22) Filed: Feb. 3, 2006

(51) Int. Cl. H04L 12/28; H04Q 7/38

(52) U.S. Cl. 370/254

(57) ABSTRACT

A method and system for facilitating command of a group determines a present rank protocol associated with users of an ad hoc wireless communication network. The method includes identifying at a first wireless device a second wireless device in operative communication with the first wireless device (step 805). A physical parameter measured at the first wireless device is then compared with a physical parameter measured at the second wireless device and wirelessly received at the first wireless device (step 810). A base rank of a user of the first wireless device is then compared with a base rank of a user of the second wireless device (step 815). A present rank of the user of the first wireless device is then determined relative to a present rank of the user of the second wireless device based on comparisons of the physical parameters and the base ranks (step 820).

### FIELD OF THE INVENTION

The present invention relates to the determination and communication of command rank protocols, and in particular to a method and system for adaptively determining relative command ranks between users in an ad hoc wireless communication network.

### BACKGROUND

Leadership, command, and management effectiveness are essential attributes of most successful organizations. Where groups of people need to be led, commanded and managed in high-stress situations, various protocols and technological tools can be used to improve group effectiveness.

For example, the military, law enforcement agencies, firefighting departments and many businesses rely on strict adherence to personnel ranking protocols to ensure that leadership and management decisions are made effectively and that commands are executed promptly. When rank structures break down in high-stress environments, such as during military battles or during firefighting or law enforcement actions, group ineffectiveness and chaos can result.

Thus most military organizations provide extensive training concerning rank protocols. If smaller units are suddenly separated from larger command structures, local leaders can be quickly identified and can act with confidence and authority, improving the effectiveness of the smaller units.

Ad hoc wireless communication networks are an example of technology tools that can be used to improve group effectiveness. Such networks are self-organizing and comprise mobile wireless communication devices that are generally not supported by base stations or other stationary infrastructure. Ad hoc wireless communication networks can be utilized effectively at impromptu incident scenes such as fire fighting scenes, law enforcement scenes and battlefields. Thus real-time wireless communications between individuals in an ad hoc wireless communication network, using for example personal radio devices, also can enable a group to act more safely, efficiently, and effectively.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a schematic diagram illustrating both general and local command structures at an incident scene such as a burning building, according to an embodiment of the present invention.

FIG. 2 is a table illustrating ranking decision parameters, variables and weight factors that are used to determine a present rank of a member of a group relative to other members of the group, depending on a particular type of situation, according to an embodiment of the present invention.

FIG. 3 is a block diagram illustrating the determination of a present rank of a user of a wireless device in an ad hoc network, according to an embodiment of the present invention.

FIG. 4 is a combined block diagram and flow diagram illustrating a method of facilitating command of a group defined by an ad hoc wireless communication network, according to an embodiment of the present invention.

FIG. 5 is a block diagram illustrating a method for determining a present rank of a user in an ad hoc wireless communication network relative to the present rank of other users in the network, according to an embodiment of the present invention.

FIG. 6 is a block diagram illustrating an alternative method, involving physical parameter weighting factors, for determining a present rank of a user in an ad hoc communication network relative to the present rank of other users in the network, according to an embodiment of the present invention.

FIG. 7 is a schematic diagram illustrating the functional components of a wireless device that is a node of an ad hoc wireless communication network, and that is adapted to perform the functions of an embodiment of the present invention.

FIG. 8 is a general flow diagram illustrating a method for facilitating command of a group defined by an ad hoc wireless communication network, according to an embodiment of the present invention.

FIG. 9 is a general flow diagram illustrating an optional method that can be added to the method described in FIG. 8, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to facilitating command of a group. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of facilitating command of a group described herein. The non-processor circuits may include, but are not limited to, a radio receiver, a radio transmitter, signal drivers, clock circuits, power source circuits, and user input devices. As such, these functions may be interpreted as steps of a method for facilitating command of a group. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the present invention employ ad hoc wireless communication networks to determine and communicate personnel rank protocols to members of a group. If the members become isolated from a central command structure, the present invention enables effective leadership, command and management decisions to proceed without disruptions or confusion concerning rank protocol. Real-time comprehension of rank protocols can be critically important in high stress environments such as fire fighting scenes, police incident scenes, battlefields, prisons, rescue scenes, and the like. The present invention thus enables adaptive and autonomous command rank protocols to be determined and communicated in real time to a group defined by users of an ad hoc wireless communication network.

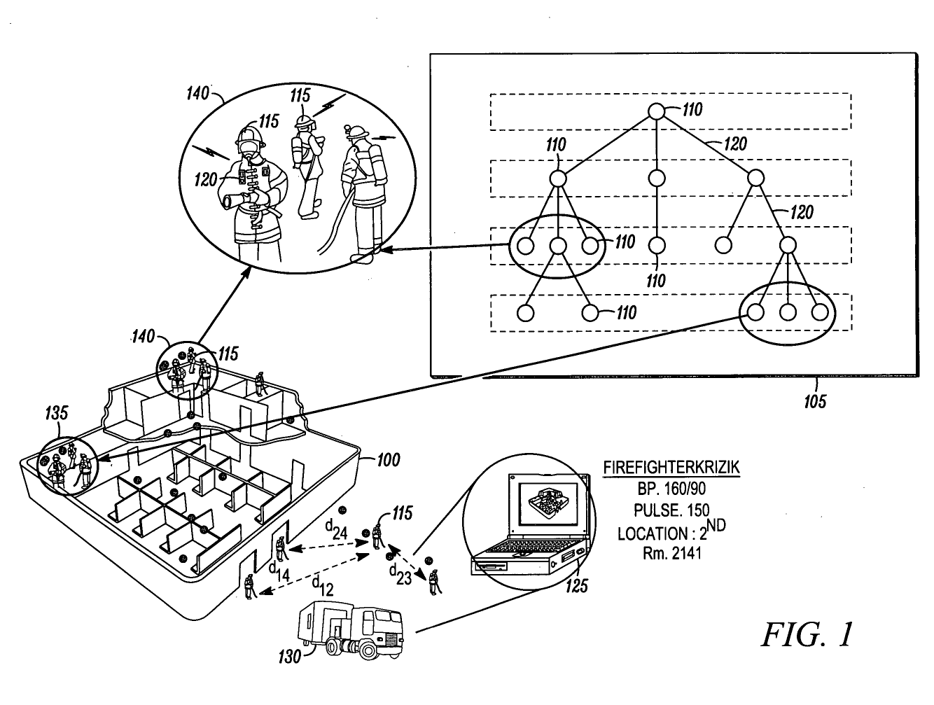

Referring to FIG. 1, a schematic diagram illustrates both general and local command structures at an incident scene such as a burning building 100, according to an embodiment of the present invention. A base rank chart 105 provides a graphical representation of an initial or base command structure of a firefighting unit, where each dot 110 represents an individual firefighter 115. The dots 110 are arranged vertically according to rank, with the highest ranking firefighter 115 represented by the dot 110 at the top of the chart 105. Lines 120, which link between the dots 110, represent a chain of command.

Each firefighter 115 wears a wireless device 120, such as a two-way radio. The wireless devices 120 form an ad hoc wireless communication network between the firefighters 115. A central command node of the ad hoc wireless communication network is shown as a notebook computer 125 located in a fire truck 130 parked near the burning building 100. Generally, all of the firefighters 115 will be in wireless communication with the central command node, and the command structure of the firefighting unit will operate according to the base rank chart 105. For example the highest ranking firefighter 115 represented at the top of the chart 105 will direct operations of all firefighters 115 using the computer 125.

However, consider a situation where certain firefighters 115 temporarily lose communication with the central command node. For example, sub-groups 135, 140 each comprise three firefighters 115 who are located near the back of the building 100. The chart 105 shows that the firefighters 115 in the sub-group 135 are of equal base rank, and the firefighters 115 in the sub-group 140 are also of equal base rank. For illustration purposes, consider that the firefighters 115 in each sub-group 135, 140 have lost communication with the central command node and can communicate only with other members of their respective sub-group 135, 140.

The sub-groups 135, 140 will generally perform most effectively if each firefighter 115 can immediately become aware of a new command sub-structure that creates a new command hierarchy among the firefighters 115 in each sub-group 135, 140. As described in more detail below, the present invention enables a method and system that facilitates the command of ad hoc groups such as the sub-groups 135, 140.

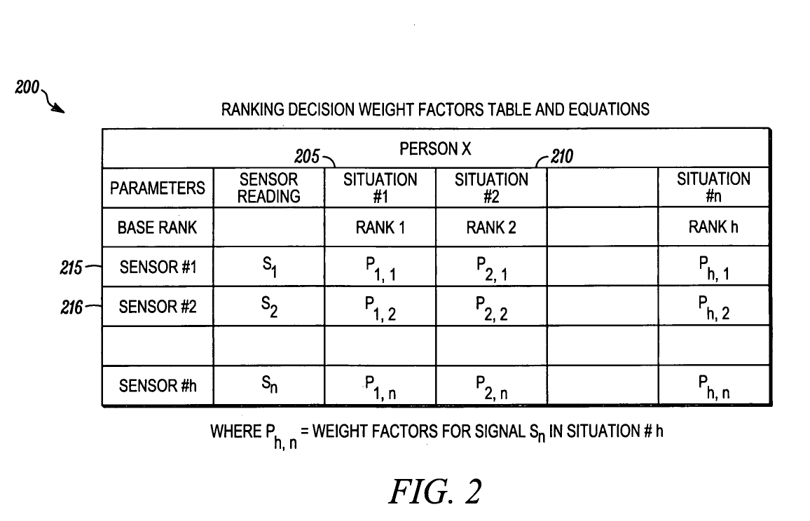

Referring to FIG. 2, a table 200 illustrates ranking decision parameters, variables and weight factors that are used to determine a present rank of a member of a group relative to other members of the group, depending on a particular type of situation, according to an embodiment of the present invention. Such a determination of present rank can be performed for example in real time by a microprocessor included in a wireless device 120. Column 205 includes values relevant to one type of situation, and column 210 includes values relevant to another type of situation. For example, consider where the group member described by the chart 200 is a firefighter 115 who is assigned a different base rank depending on a type of fire that he or she fights. Where the firefighter has particular expertise in fighting, for example, chemical fires, then he or she may be assigned a higher base rank when fighting chemical fires than when fighting other types of fires. Thus the firefighter 115 is assigned a base “Rank 1” in a situation represented by column 205 and is assigned a base “Rank 2” in a situation represented by column 210.

Row 215 includes weighting factors “P” that are relevant to a particular type of sensor in a particular type of situation. The sensor can be any type of sensor that measures a physical parameter that is relevant to the command ranking of members of a group. For example, a sensor can be carried on an individual member of a group, such as one of the firefighters 115, and can measure the body temperature of the individual. A firefighter 115 whose body temperature rises above a certain level may be considered to be physically compromised and incapable of making reliable command decisions. Further, a parameter such as body temperature may be more relevant to a present rank of a firefighter 115 inside a hot building than it is when the same firefighter 115 fights a fire outdoors. Thus row 215 shows that the weighting factors “P_{h,1}” of a given “Sensor #1” can change depending on a particular situation.

As a further example, row 216 may include weighting factors that are relevant to a heart rate sensor. Here, heart rate may be more relevant to the command rank of a firefighter 115 fighting a forest fire, where significant running may be required, than to the rank of a firefighter 115 fighting a localized building fire. Thus row 216 shows that the weighting factors “P_{h,2}” of a given “Sensor #2” can change depending on a particular situation.

The sensor values defined by the table 200 can be based on various types of sensors that measure various types of physical parameters. For example, such sensors can measure position, environment temperature, air quality, air capacity of a Self Contained Breathing Apparatus (SCBA), or physiological parameters such as body temperature, heart rate, blood pressure, hydration level, and indicators of emotional stress such as voice quality. Still other examples of physical parameters that can be used according to embodiments of the present invention include chemical levels (e.g., carbon monoxide, carbon dioxide, hydrogen sulfide, hydrocarbon concentration) and CBRNE parameters (i.e., Chemical agents, Biological agents, Radiological concentration, Nuclear concentration, Explosive concentration), and environmental sound (e.g., gunfire, explosions). Such physical parameters, combined with the weighting factors given in the table 200, can then be used to determine a new rank of an individual, such as “Person x”, according to the following Equation 1:
New Rank (Person x)=f(Personx(rank h), S₁P_{h,1}, S₂P_{h,2}, . . . , SₙP_{h,n}), Eq. 1
where Sₙ is a value of a particular sensor and P_{h,n} is a weighting factor.

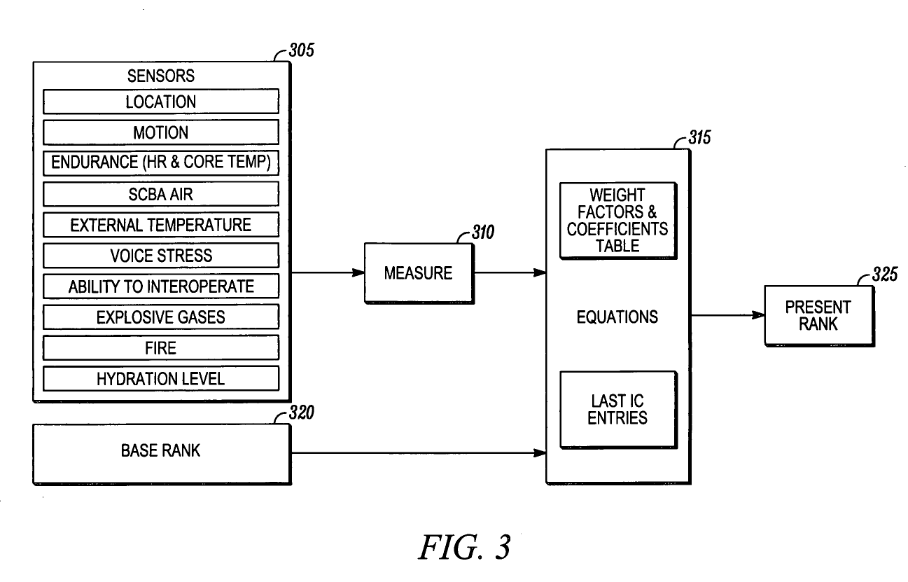

Referring to FIG. 3, a block diagram illustrates the determination of a present rank of a user of a wireless device 120 in an ad hoc network, according to an embodiment of the present invention. FIG. 3 is effectively a pictorial representation of the function defined by Equation 1. Block 305 represents the various types of sensors used to measure different physical parameters. At block 310 measurements are recorded and input into an equation block 315. At block 320, a base rank of a user is also input into the equation block 315. Block 315 then uses the physical parameters measured by the sensors, weighting factors, base rank, and other variables to provide, at block 325, a present rank of the user. Accordingly, present rank protocols can be broadcast or otherwise transmitted to all users in an ad hoc wireless communication network.

Determining the present rank of a user according to an embodiment of the present invention also can include modifying network privileges associated with the user. For example, a firefighter 115 who is newly designated as a leader of a sub-group 135, 140 can automatically and immediately obtain new software privileges such as read/write privileges associated with an ad hoc wireless communication network. Thus, according to such an embodiment, the device 120 of a newly designated leader can be automatically reconfigured to provide network services and access privileges that are associated with a group leader.

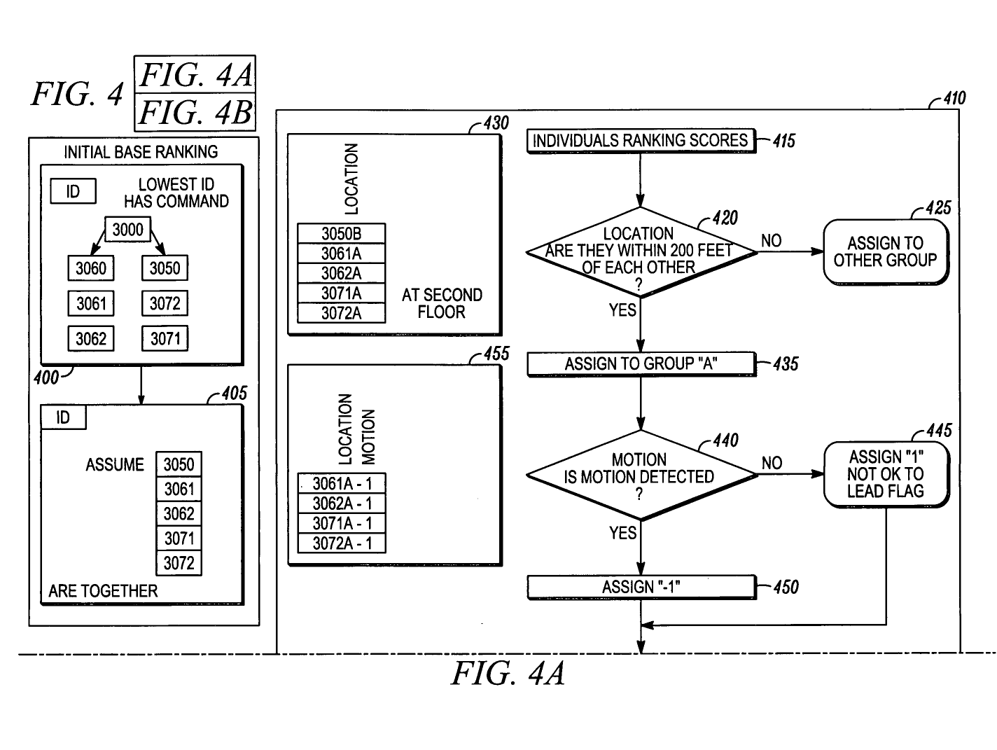

Referring to FIG. 4, a combined block diagram and flow diagram further illustrate a method of facilitating command of a group defined by an ad hoc wireless communication network, according to an embodiment of the present invention. Block 400 illustrates a base command structure where individuals in a group are each represented by an identification (ID) number, where a lower ID number represents a higher rank. Thus initially the individual having the ID number “3000” is in command. Next, at block 405, consider that five members of the group shown in block 400 are isolated from the other members of the group, so that the individuals represented in block 405 are able to communicate only with each other. Block 410 then illustrates a method of determining a present rank of each individual represented in block 405 relative to the other individuals represented in block 405. Those skilled in the art will appreciate that the method described in block 410 can be executed on various types of devices such as, in the example above, the wireless devices 120 worn by the firefighters 115.

At step 415, the base rank of each wireless device user in an ad hoc network comprising the individuals represented in block 405 is provided from a database. At step 420 it is determined whether each user is within close proximity, such as within 200 feet, of the other users in the network. Such position determinations can be made for example using Global Positioning System (GPS), Dead Reckoning Module (DRM), Inertial Navigation System (INS), network-based triangulation or multilateration, or other outdoor or in-building position system technology. If a user is determined not to be within close proximity, then at step 425 that user is assigned to another group. For example, block 430 shows that individual “3050” is located on a second floor away from the other users and is thus assigned to a group “B”. The remaining users are within close proximity to each other and therefore, at step 435, the remaining users are all assigned to be members of a group “A”.

At step 440 it is determined whether each member of group “A” is moving in a manner that demonstrates physical capability. For example, motion sensors on an individual's clothing can be used to measure motion of the individual's limbs. If it is determined that a member in group “A” is not moving effectively, then at step 445 that member is assigned a “not OK to lead” flag defined by a value of “1”. If a member is moving effectively then at step 450 he or she is assigned an “OK to lead” flag defined by a value of “−1”. For example, block 455 shows that all individuals in group “A” are moving adequately and are assigned a motion value of “−1”.

At step 460 it is determined whether each member of group “A” is exhibiting adequate endurance. For example, endurance can be measured using heart rate, perspiration, or body temperature sensors. If it is determined that a member in group “A” does not exhibit adequate endurance, then at step 465 that member is assigned a “not OK to lead” flag defined by a value of “1”. If a member does exhibit adequate endurance, then at step 470 he or she is assigned an “OK to lead” flag defined by a value of “−1”. For example, block 475 shows that all individuals in group “A” exhibit adequate endurance and are assigned an endurance value of “−1”, except for member “3061” whose endurance is determined to be inadequate and who is assigned a “not OK to lead flag” having a value of “1”.

At step 480 it is determined whether each member of group “A” is exhibiting adequate air capacity. For example, air capacity can be measured using a pressure gauge in a SCBA tank. If it is determined that a member in group “A” does not exhibit adequate air capacity, then at step 485 that member is assigned a “not OK to lead” flag defined by a value of “1”. If a member does exhibit adequate air capacity, then at step 490 he or she is assigned an “OK to lead” flag defined by a value of “−1”. For example, block 495 shows that all individuals in group “A” exhibit adequate air capacity and are assigned an SCBA value of “−1”, except for member “3072” whose air capacity is determined to be inadequate and who is assigned a “not OK to lead flag” having a value of “1”.

In light of the present invention, as will be appreciated by those skilled in the art, the method defined above concerning block 410 can thus continue for various other physical parameters such as external temperature or the voice quality of a member of the group defined by block 405. For example a group member exhibiting signs of panic may be assigned a “not OK to lead” flag. Still other examples include parameters associated with an ad hoc network user's communication equipment, such as an ad hoc network communication Quality of Service (QoS), or the remaining battery power of a wireless device 120.

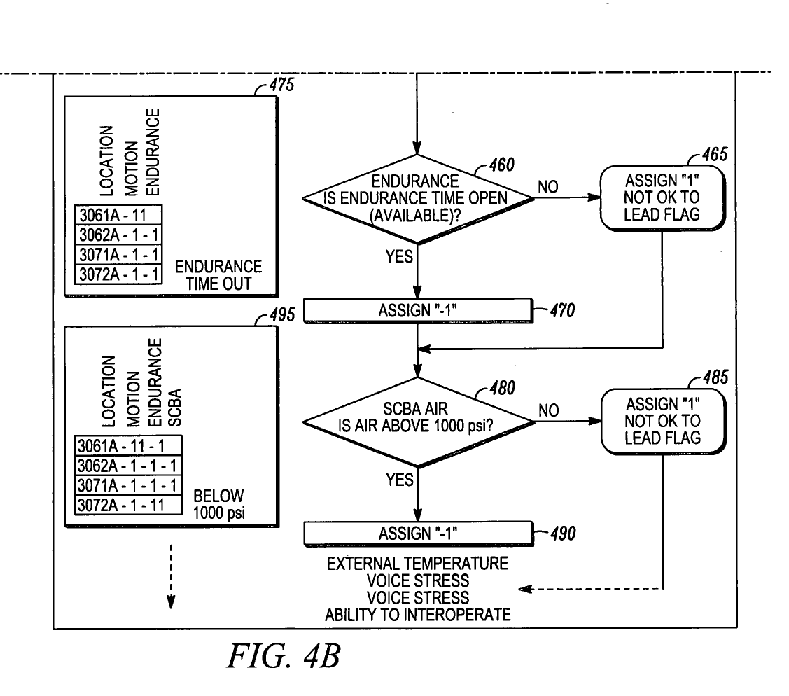

Referring to FIG. 5, a block diagram illustrates a method for determining a present rank of a user in an ad hoc communication network relative to the present rank of other users in the network, according to an embodiment of the present invention. As shown, the values of the “OK to lead” and “not OK to lead” flags are added to the original base rank of each user in the ad hoc network. Whereas the individual with ID “3061” has the highest base rank, after adding all of the flags together with the base ranks, the individual with ID “3062” acquires a new rank of “3055” and is assigned leadership of the group “A” defined by block 455.

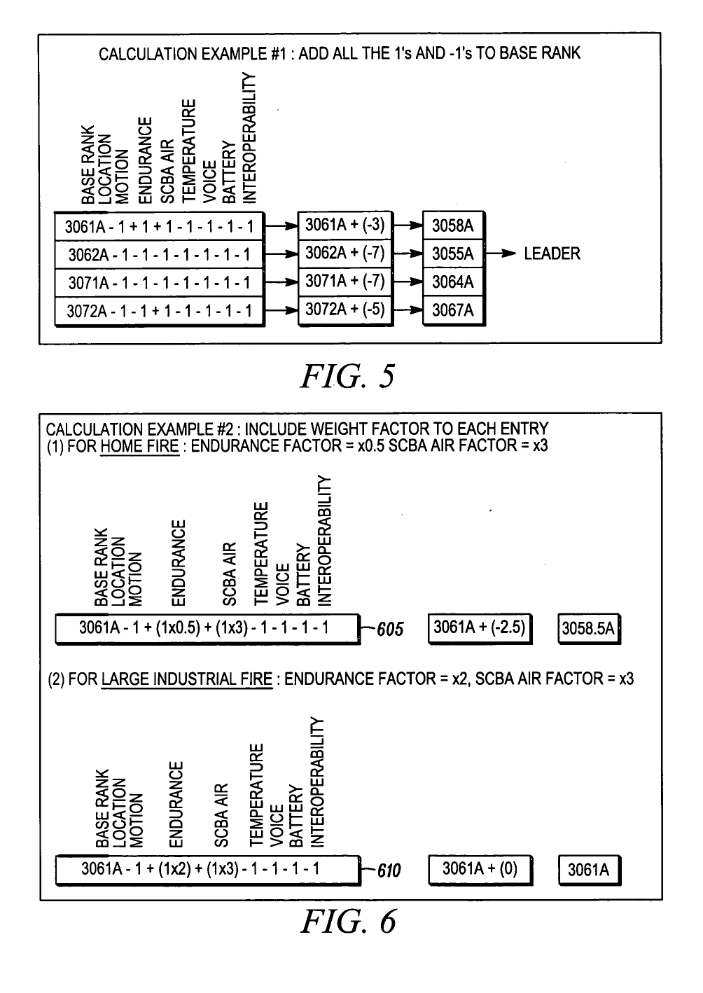

Referring to FIG. 6, a block diagram illustrates an alternative method, involving physical parameter weighting factors, for determining a present rank of a user in an ad hoc communication network relative to the present rank of other users in the network, according to an embodiment of the present invention. As shown, rather than adding the raw values of the “OK to lead” and “not OK to lead” flags, certain values are first multiplied by a weighting factor. For example, the weighting factors are based on a particular ad hoc network user's skills or capabilities in particular situations, as described above with reference to FIG. 2. Thus, as shown in block 605, the user having ID “3061” when fighting a home fire is assigned an endurance weighting factor of 0.5 and an SCBA weighting factor of 3.0. However, as shown in block 610, the same user having ID “3061” when fighting a large industrial fire—where increased physical stamina may be required—is assigned an endurance weighting factor of 2.0 and an SCBA weighting factor of 3.0. Such weighting factors thus enable a present rank protocol of users in a network to be optimized based on present circumstances such as the external environment and the present skills, abilities, or disabilities of the users.

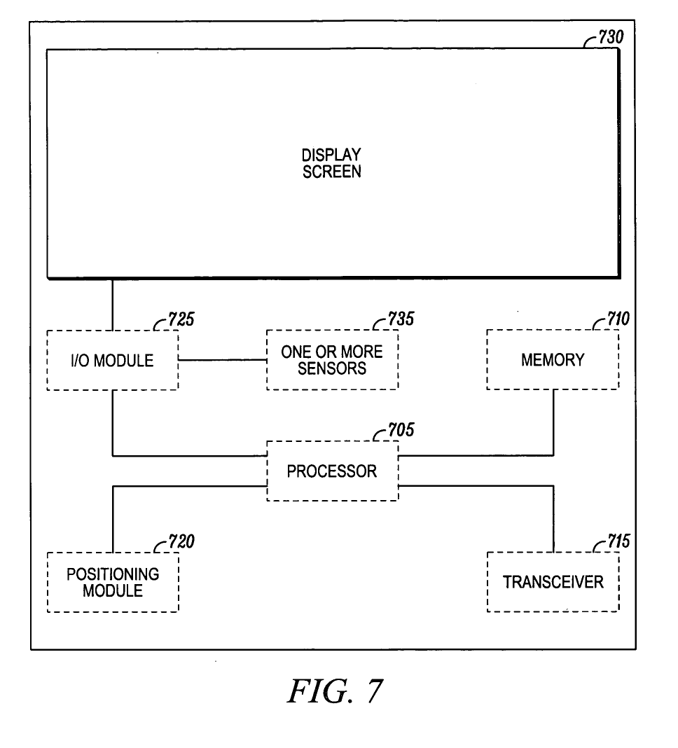

Referring to FIG. 7, a schematic diagram illustrates the functional components of a wireless device 120 that is a node of an ad hoc wireless communication network, and that is adapted to perform the functions of an embodiment of the present invention. A processor 705 is operatively connected to various functional modules such as a memory 710, a transceiver 715, a positioning module 720 such as a Global Positioning System (GPS) module or other type of navigational module, and an Input/Output (I/O) module 725. The I/O module 725 is operatively connected to a display screen 730 and to other elements (not shown) such as a keypad, microphone, speaker, and camera. The I/O module 725 is also operatively connected to one or more sensors 735 such as heart rate monitors, thermometers, air quality sensors, and chemical sensors used to measure physical parameters associated with the methods of the present invention. Such sensors 735 can be incorporated into the wireless device 120 or, for example, can be incorporated into a wireless device user's equipment such as clothing, helmets, boots, or SCBA tanks. For purposes of the present invention, physical parameters measured by the sensors 735 that are either incorporated into a wireless device 120 or incorporated into a wireless device user's equipment are considered to be measured at a wireless device 120. Further, those skilled in the art will appreciate that the wireless device 120 can be embodied in various types of hardware such as two-way radios, mobile phones, notebook computers, or personal digital assistants (PDAs).

The memory 710 can comprise various types of memory such as a random access memory (e.g., static random access memory (SRAM)), read only memory (e.g., programmable read only memory (PROM), or electrically erasable programmable read only memory (EPROM)), or hybrid memory (e.g., FLASH) as is well known in the art. The processor 705 then accesses a computer useable medium in the memory 710, which medium includes computer readable program code components configured to cause the wireless device 120 to execute the functions of the present invention. Thus by receiving signals through the transceiver 715 the computer readable program code components are configured to identify at a first wireless device 120 a second wireless device 120 in operative communication with the first wireless device 120. Data representative of physical parameters measured at the sensors 735 are transmitted through the I/O module 725 and processed by the processor 705. The computer readable program code components are then configured to compare a physical parameter measured at the first wireless device 120 with a physical parameter measured at the second wireless device 120. The computer readable program code components are also configured to compare a base rank of a user of the first wireless device 120 with a base rank of a user of the second wireless device 120. The base ranks of users are stored in the memory 710 and retrieved by the processor 705. The computer readable program code components are then configured to determine a present rank of the user of the first wireless device 120 relative to a present rank of the user of the second wireless device 120 based on the comparisons of the physical parameters and the base ranks. Results of the ranking determination then can be presented to a user through the I/O module 725, such as by providing a graphical display on the display screen 730.

Physical parameters measured for purposes of the command ranking aspects of the present invention, also can be used for other purposes. For example, consider a first user in an ad hoc wireless communication network that receives air toxicity data from an air quality sensor incorporated into his or her wireless device 120. The first user then receives temperature data from a thermometer incorporated into a second wireless device 120 used by a second user in the network. The temperature data is transmitted wirelessly from the first device 120 to the second device 120. The first device 120 can then use both the air toxicity data and the temperature data to determine present relative command rankings between the first user and the second user as describe above. Further, if the air toxicity data indicates that the air near the first user is flammable, and the temperature data indicates that the temperature near the second user is nearing an ignition point, then the combined data can be used to trigger an evacuation alarm at both the first and second devices 120.

In light of the present invention, those skilled in the art will further appreciate that data from sensors associated with a wireless device 120, also can be combined with data from other environmental sensors that are not associated with the wireless device 120. For example, environmental sensors installed in buildings such as structural integrity sensors, temperature sensors, air quality sensors, and toxicity sensors can also communicate with a wireless device 120 and be used to activate various alerts and alarms at a wireless device 120 or at a central command node.

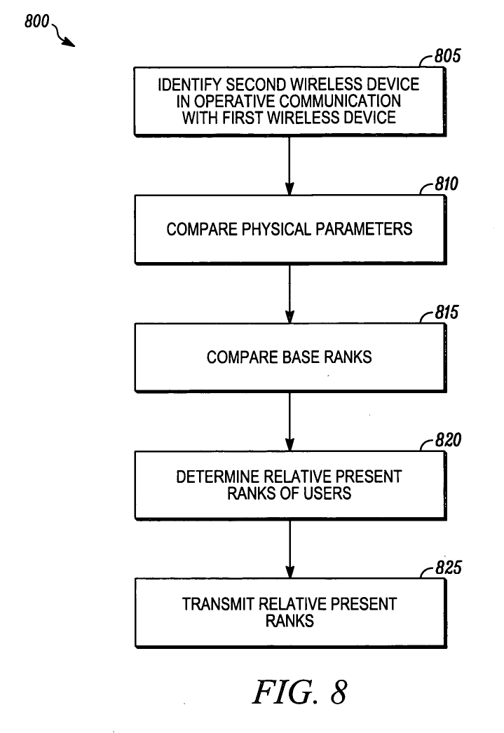

Referring to FIG. 8, a general flow diagram illustrates a method 800 for facilitating command of a group defined by an ad hoc wireless communication network, according to an embodiment of the present invention. For illustration purposes, the method 800 concerns interactions between only two wireless devices 120 in an ad hoc network; however, those skilled in the art will appreciate that the method 800 is also relevant to much larger networks involving numerous wireless devices 120. First, at step 805 a second wireless device 120 is identified in operative communication with a first wireless device 120. At step 810, a physical parameter measured at the first wireless device 120 is compared with a physical parameter measured at the second wireless device 120 and wirelessly received at the first wireless device 120. As disclosed herein, comparing physical parameters measured at different wireless devices 120 can comprise for example comparing sensor data output from physical sensors or can comprise comparing other data derived from sensor data, such as “OK to lead” or “not OK to lead” flags. At step 815, a base rank of a user of the first wireless device 120 is compared with a base rank of a user of the second wireless device 120. As described above, the comparisons of the physical parameters and the base ranks can be performed using a single function. Then, at step 820, a present rank of the user of the first wireless device 120 is determined relative to a present rank of the user of the second wireless device 120 based on comparisons of the physical parameters and the base ranks. At step 825, the present rank of the user of the first wireless device 120 relative to the present rank of the user of the second wireless device 120 is transmitted from the first wireless device 120 to the second wireless device 120.

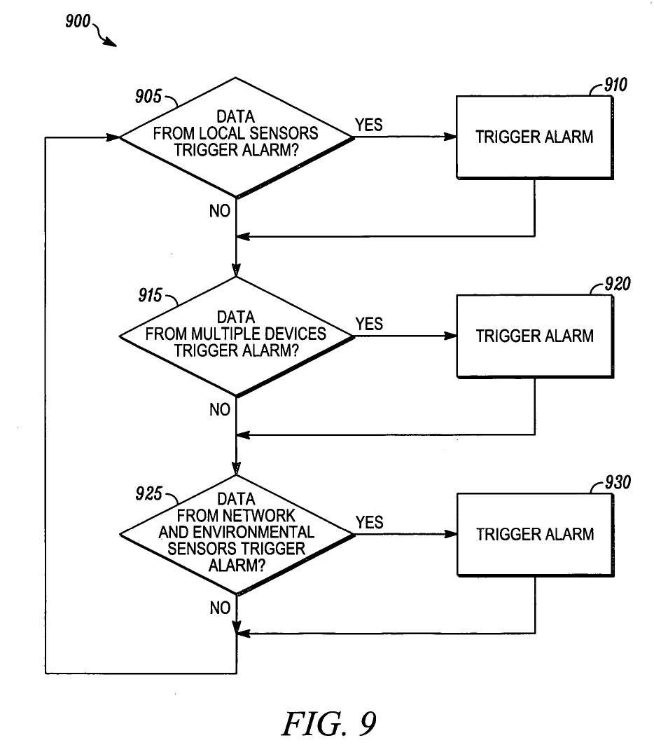

Referring to FIG. 9, a general flow diagram illustrates an optional method 900 for triggering alarms, which can be added to the method 800, according to an embodiment of the present invention. At step 905, it is determined whether data from local sensors associated with a first wireless device 120 can be compared and whether the compared data warrants triggering an alarm that will alert a user of the first device 120 and perhaps also alert users of other devices 120. If so, at step 910 an alarm is triggered. Otherwise, at step 915, it is determined whether data from sensors associated with multiple devices 120, such as data from a sensor associated with a first wireless device 120 and data from a sensor associated with a second wireless device 120, can be compared and whether the compared data warrants triggering an alarm that will alert a user of the first device 120 and perhaps also alert users of other devices 120. If so, at step 920 an alarm is triggered. Otherwise, at step 925, it is determined whether data from sensors associated with at least one wireless device 120 and data from an environmental sensor that is not associated with a particular wireless device 120, can be compared and whether the compared data warrants triggering an alarm that will alert a user of the first device 120 and perhaps also alert users of other devices 120. If so, at step 930 an alarm is triggered. The method 900 then returns to step 905 where the method 900 can be repeated in a continuous monitoring process.

Advantages of embodiments of the present invention therefore include the ability to determine and communicate personnel rank protocols to users of an ad hoc wireless communication network in real time. If network users become isolated from a central command structure, the present invention enables effective leadership, command and management decisions to proceed without confusion concerning rank protocol. Further, rank protocols can be determined in real time based on situation-specific functions, resulting in improved, adaptive and autonomous rank protocols based on the immediate skills, abilities or disabilities of ad hoc wireless communication network users. Information from multiple sensors used to determine present rank protocols also can be used for other purposes such as alerting network users of dangers.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for facilitating command of a group within an ad hoc wireless communication network, the method comprising:
identifying at a first wireless device a second wireless device in operative communication with the first wireless device;
comparing a physical parameter measured at the first wireless device with a physical parameter measured at the second wireless device and wirelessly received at the first wireless device;
comparing a base rank of a user of the first wireless device with a base rank of a user of the second wireless device; and
determining a present rank of the user of the first wireless device relative to a present rank of the user of the second wireless device based on the comparisons of the physical parameters and the base ranks.

2. The method of claim 1, wherein the physical parameters measured at the first and second wireless devices are selected from a group comprising: position; environment temperature; physiological parameters including body temperature, heart rate, blood pressure, and voice quality; air quality; air capacity; motion; communication Quality of Service (QoS); and battery power.

3. The method of claim 1, wherein the present rank of the user of the first wireless device is a function of the base rank of the user of the first wireless device plus a weighted function of the physical parameter measured at the first wireless device.

4. The method of claim 3, wherein the weighted function of the physical parameter measured at the first wireless device comprises a weighting factor determined based on a particular situation involving the user of the first wireless device.

5. The method of claim 1, wherein determining the present rank of the user of the first wireless device relative to the present rank of the user of the second wireless device comprises comparing a plurality of physical parameters measured at the first wireless device with a plurality of physical parameters measured at the second wireless device.

6. The method of claim 1, further comprising transmitting to the second wireless device the present rank of the user of the first wireless device relative to the present rank of the user of the second wireless device.

7. The method of claim 1, further comprising triggering an alarm at the first wireless device based on a comparison of a physical parameter measured at the first wireless device with a physical parameter measured at the at second wireless device and wirelessly received at the first wireless device.

8. The method of claim 1, further comprising receiving at the first wireless device an environmental signal from an environmental sensor and triggering an alarm at the first wireless device in response to the environmental signal.

9. The method of claim 8, wherein the environmental sensor is selected from a group comprising: structural integrity sensors, temperature sensors, air quality sensors, toxicity sensors, sound sensors, biological agent sensors, radiological concentration sensors, nuclear concentration sensors, and explosive concentration sensors.

10. The method of claim 1, wherein both comparing a physical parameter measured at the first wireless device with a physical parameter measured at the second wireless device, and comparing a base rank of a user of the first wireless device with a base rank of a user of the second wireless device, are performed according to a single function.

11. The method of claim 1, wherein determining a present rank of the user of the first wireless device relative to a present rank of the user of the second wireless device comprises reconfiguring network privileges associated with the first wireless device based on the present rank of the user of the first wireless device.

12. A system for facilitating command of a group defined by an ad hoc wireless communication network, comprising:
computer readable program code components configured to identify at a first wireless device a second wireless device in operative communication with the first wireless device;
computer readable program code components configured to compare a physical parameter measured at the first wireless device with a physical parameter measured at the second wireless device and wirelessly received at the first wireless device;
computer readable program code components configured to compare a base rank of a user of the first wireless device with a base rank of a user of the second wireless device; and
computer readable program code components configured to determine a present rank of the user of the first wireless device relative to a present rank of the user of the second wireless device based on the comparisons of the physical parameters and the base ranks.

13. The system of claim 12, wherein the physical parameters measured at the first and second wireless devices are selected from a group comprising: position; environment temperature; physiological parameters including body temperature, heart rate, blood pressure, and voice quality; air quality; air capacity; motion; communication Quality of Service (QoS); and battery power.

14. The system of claim 12, wherein the present rank of the user of the first wireless device is a function of the base rank of the user of the first wireless device plus a weighted function of the physical parameter measured at the first wireless device.

15. The system of claim 14, wherein the weighted function of the physical parameter measured at the first wireless device comprises a weighting factor determined based on a particular situation involving the user of the first wireless device.

16. The system of claim 12, wherein determining the present rank of the user of the first wireless device relative to the present rank of the user of the second wireless device comprises comparing a plurality of physical parameters measured at the first wireless device with a plurality of physical parameters measured at the second wireless device.

17. The system of claim 12, further comprising computer readable program code components configured to reconfigure network privileges associated with the first wireless device based on the present rank of the user of the first wireless device.

18. The system of claim 12, further comprising computer readable program code components configured to trigger an alarm at the first wireless device based on a comparison of a physical parameter measured at the first wireless device with a physical parameter measured at the at second wireless device and wirelessly received at the first wireless device.

19. The system of claim 12, further comprising computer readable program code components configured to receive at the first wireless device an environmental signal from an environmental sensor and triggering an alarm at the first wireless device in response to the environmental signal.

20. The system of claim 19, wherein the environmental sensor is selected from a group comprising: structural integrity sensors, temperature sensors, air quality sensors, toxicity sensors, sound sensors, biological agent sensors, radiological concentration sensors, nuclear concentration sensors, and explosive concentration sensors.

21. The system of claim 12, wherein both comparing a physical parameter measured at the first wireless device with a physical parameter measured at the second wireless device, and comparing a base rank of a user of the first wireless device with a base rank of a user of the second wireless device, are performed according to a single function.

22. A system for facilitating command of a group defined by an ad hoc wireless communication network, comprising:
means for identifying at a first wireless device a second wireless device in operative communication with the first wireless device;
means for comparing a physical parameter measured at the first wireless device with a physical parameter measured at the second wireless device and wirelessly received at the first wireless device;
means for comparing a base rank of a user of the first wireless device with a base rank of a user of the second wireless device; and
means for determining a present rank of the user of the first wireless device relative to a present rank of the user of the second wireless device based on the comparisons of the physical parameters and the base ranks.
